(19) United States
(12) Patent Application Publication
(10) Pub. No.: US 2022/0187429 A1
(43) Pub. Date: Jun. 16, 2022

(54) OPTICAL RANGING DEVICE

(71) Applicant: DENSO CORPORATION, Kariya-city (JP)

(72) Inventors: Akifumi UENO, Kariya-city (JP); Shinji KASHIWADA, Kariya-city (JP); Fumiaki MIZUNO, Kariya-city (JP)

(21) Appl. No.: 17/653,278

(22) Filed: Mar. 2, 2022

Related U.S. Application Data
(63) Continuation of application No. PCT/JP2020/032882, filed on Aug. 31, 2020.

(30) Foreign Application Priority Data
Sep. 4, 2019 (JP) 2019-161004
Aug. 21, 2020 (JP) 2020-139972

(51) Int. Cl. G01S 7/481; G01S 17/42; G01S 17/10; G01S 17/89

(52) U.S. Cl. CPC G01S 7/4817; G01S 17/89; G01S 17/10; G01S 17/42

(57) ABSTRACT

An optical ranging device comprises: a light emitting portion emitting laser light; a scanning portion performing a scan using the laser light emitted from the light emitting portion; a light receiving portion receiving incident light; a rotation angle sensor detecting a rotation angle of the scanning portion; and a control device configured to: acquire the rotation angle and output a drive signal to the light emitting portion, and use a correction value determined using at least an emission delay period from when the rotation angle is acquired to when the laser light is emitted, to perform at least one of a first correction control of an emission timing of the laser light and a second correction control of a detection angle of distance data generated using a received light signal output from the light receiving portion that received the laser light.

### CROSS-REFERENCE TO RELATED APPLICATION

The present application is a continuation application of International Application No. PCT/JP2020/032882, filed on Aug. 31, 2020, which claims priority to Japanese Patent Application No. 2019-161004 filed on Sep. 4, 2019 and Japanese Patent Application No. 2020-139972 filed on Aug. 21, 2020. The contents of these applications are incorporated herein by reference in their entirety.

### BACKGROUND

### Technical Field

The present disclosure relates to an optical ranging device.

### Background Art

A technique used in an optical ranging device that reflects laser light emitted from a light emitting portion with a mirror is known that obtains the rotation angle of the mirror using a rotation angle sensor and outputs a drive signal to the light emitting portion at intervals of a predetermined rotation angle.

### SUMMARY

In the present disclosure, provided is an optical ranging device as the following.

The optical ranging device comprises a light emitting portion, a scanning portion, a light receiving portion, a rotation angle sensor, and a control device. The control device is configured to: acquire a rotation angle of the scanning portion and output a drive signal to the light emitting portion, and use a correction value to perform at least one of a first correction control and a second correction control, the correction value being determined using at least an emission delay period from when the rotation angle is acquired to when laser light is emitted, and a correspondence relationship between a rotation angle of the rotation angle sensor and a detection error in the rotation angle, the first correction control being a correction of an emission timing of the laser light, and the second correction control being a correction of a detection angle of distance data generated using a received light signal output from the light receiving portion that received the laser light.

### BRIEF DESCRIPTION OF THE DRAWINGS

The above and other objects, features, and advantages of the present disclosure will be better understood from the following detailed description with reference to the accompanying drawings. In the drawings,

FIG. 1 is an illustrative diagram showing the configuration of an optical ranging device according to a first embodiment;

FIG. 2 is an illustrative diagram showing an outline of control for adjusting the emission timing of laser light performed by the control device;

FIG. 3 is a plan view illustrating the output timings of drive signals and the emission timings of laser light using the rotation angle of the rotating portion;

FIG. 4 is an illustrative diagram showing the configuration of an optical ranging device according to a second embodiment;

FIG. 5 is an illustrative diagram showing an outline of control for adjusting the emission timing of laser light according to the second embodiment;

FIG. 6 is an illustrative diagram that uses rotation angles to conceptually illustrate the timings at which generation of the drive signals is started in the second embodiment;

FIG. 7 is an illustrative diagram showing the configuration of an optical ranging device according to a third embodiment;

FIG. 8 is an illustrative diagram showing the configuration of an optical ranging device according to a fourth embodiment;

FIG. 9 is an illustrative diagram showing a correspondence map of the rotation angle and the timing at which generation of a drive signal is started;

FIG. 10 is an illustrative diagram showing the configuration of an optical ranging device according to a fifth embodiment;

FIG. 11 is an illustrative diagram conceptually showing the correction value calculated by the correction value calculating unit; and

FIG. 12 is an illustrative diagram showing the errors in detection angles with respect to the rotation angles detected by the rotation angle sensor.

### DETAILED DESCRIPTION OF THE PREFERRED EMBODIMENTS

Conventionally, for example, in JP 2011-85577 A, the delay period from the time the mirror's rotation angle is acquired to the time the laser light is emitted is not taken into consideration.

The present disclosure can be realized as the following modes.

[Mode 1]

According to a mode of the present disclosure, an optical ranging device is provided. The optical ranging device comprises: a light emitting portion configured to emit laser light; a scanning portion configured to perform a scan using the laser light emitted from the light emitting portion; a light receiving portion configured to receive incident light; a rotation angle sensor configured to detect a rotation angle of the scanning portion; and a control device configured to: acquire the rotation angle and output a drive signal to the light emitting portion, and use a correction value to perform at least one of a first correction control and a second correction control, the correction value being determined using at least an emission delay period from when the rotation angle is acquired to when the laser light is emitted, and a correspondence relationship between a rotation angle of the rotation angle sensor and a detection error in the rotation angle, the first correction control being a correction of an emission timing of the laser light, and the second correction control being a correction of a detection angle of distance data generated using a received light signal output from the light receiving portion that received the laser light.

According to the optical ranging device of this mode, the control device corrects the emission timing of laser light or the detection angle of an object using a correction value determined using at least the emission delay period. Therefore, in an optical ranging device that has emission delay, it is possible to obtain distance data that reduces the deviation between the rotation angle of the scanning portion at the timing laser light is emitted from the light emitting portion and the set rotation angle of the scanning portion, which is set in advance, at the timing for emitting laser light.

### A. First Embodiment

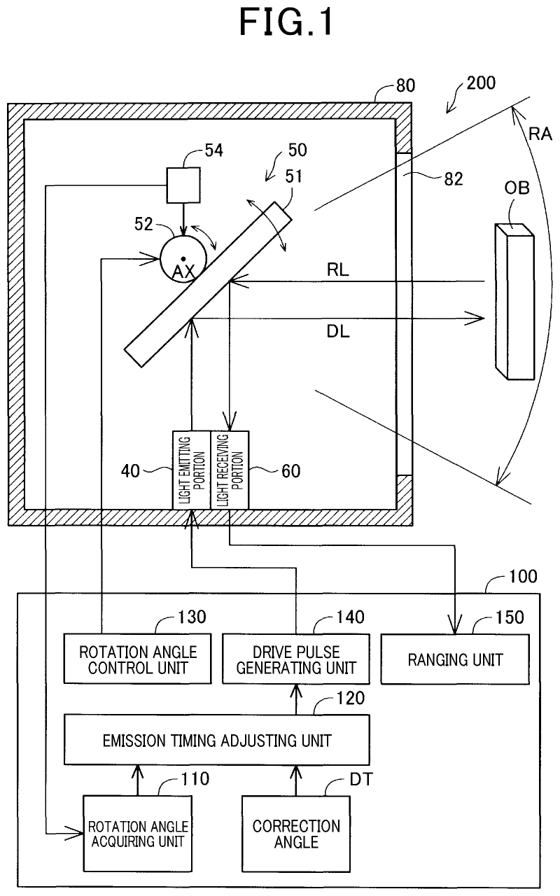

As shown in FIG. 1, the optical ranging device 200 as the first embodiment of the present disclosure includes a housing 80, a light emitting portion 40, a scanning portion 50, a light receiving portion 60, and a control device 100. The light emitting portion 40, the scanning portion 50, and the light receiving portion 60 are placed inside the housing 80 which includes a window portion 82. The window portion 82 is made of a material that transmits laser light, such as glass. The optical ranging device 200 is, for example, mounted on a vehicle to detect an obstacle or measure the distance to the obstacle.

The light emitting portion 40 includes a laser diode as a light source, and emits laser light DL for distance measurement. The laser diode includes a semiconductor layer having an active layer inside it that generates laser light. When a drive signal is output from a drive pulse generating unit 140, which will be described later, and reaches the light emitting portion 40, the current flowing through the semiconductor layer causes light emission in the active layer, and the generated light is sent out as laser light DL using stimulated emission. The period from the time when the drive signal is output to the light emitting portion 40 to the time when laser light DL is emitted from the light emitting portion 40 is also referred to as a second delay period. Another light source such as a solid-state laser may be used as the light source of the light emitting portion 40 instead of the laser diode.

A so-called one-dimensional scanner forms the scanning portion 50. The scanning portion 50 includes a mirror 51, a rotating portion 52, and a rotation angle sensor 54. Laser light DL emitted from the light emitting portion 40 is reflected by the mirror 51, passes through the window portion 82, and is emitted outside the housing 80. The rotating portion 52 receives a control signal from a rotation angle control unit 130, which will be described later, and rotates back and forth with the central axis AX as the rotation axis. The swinging of the mirror 51 fixed to the rotating portion 52 causes laser light DL to scan the scan region RA.

In this embodiment, an optical rotary encoder is employed in the rotation angle sensor 54. The rotation angle sensor 54 generates A- and B-phase pulse signals, and a Z-phase pulse signal for detecting the reference position of the rotating portion 52.

The light receiving portion 60 has a plurality of pixels arranged two-dimensionally. Each pixel is composed of a plurality of light receiving elements. Each pixel may also be composed of one light receiving element. Each light receiving element outputs a signal corresponding to the incident intensity of the reflected light RL reflected by a target, for example an object OB in the scan range RA of laser light DL. In this embodiment, single photon avalanche diode (SPAD) is used as the light receiving element. Alternatively, PIN photodiode may be used as the light receiving element. When a SPAD receives light (photons), it outputs an output pulse signal indicative of the incidence of light. When a light receiving element of the light receiving portion 60 receives the reflected light RL, it outputs a pulse signal corresponding to the state in which the incident light is received to the control device 100.

The control device 100 includes a well-known microprocessor and memory. The microprocessor executes programs prepared in advance to control a rotation angle acquiring unit 110, an emission timing adjusting unit 120, a rotation angle controlling unit 130, a drive pulse generating unit 140, and a ranging unit 150.

The ranging unit 150 measures the distance to a target within the scan range RA by using the so-called TOF (time of flight). More specifically, the ranging unit 150 adds together the received light signals output by each SPAD of the light receiving portion 60 to generate a histogram, and detects the position (time) of the peak of the signal corresponding to the reflected light RL from the generated histogram. The light emitting portion 40 may emit laser light DL a plurality of times so that the ranging unit 150 acquires the sum of the output signals of each SPAD a plurality of times, and the histogram may be generated by adding up the sums. The ranging unit 150 calculates the distance to the object OB serving as a target using the time from when the light emitting portion 40 outputs laser light DL to when the light receiving elements of the light receiving portion 60 receive the reflected light RL. At each detection angle within the scan range RA, the distance data generated by the ranging unit 150 is acquired for each light receiving element or each pixel composed of a plurality of light receiving elements of the light receiving portion 60. The distance data is generated as point cloud data for each scan of the scan range RA.

The rotation angle control unit 130 outputs a control signal to the rotating portion 52 to rotate the rotating portion 52. In this embodiment, the rotation angle control unit 130 makes the rotating portion 52 rotate back and forth at a predetermined constant speed.

The rotation angle acquiring unit 110 detects the pulse edges of the A- and B-phase pulse signals output from the rotation angle sensor 54. The rotation angle acquiring unit 110 acquires the rotation angle of the rotating portion 52 according to the counts of the A- and B-phase pulse signals. The acquired result of the rotation angle of the rotating portion 52 is output to the emission timing adjusting unit 120. The drive pulse generating unit 140 receives a command signal from the emission timing adjusting unit 120, generates a drive signal for causing the laser diode to emit light, and outputs the drive signal to the light emission part 40. The time period from the time when the rotation angle acquiring unit 110 detects the pulse edges to the time when the drive pulse generating unit 140 outputs the drive signal is also referred to as a first delay period.

The emission timing adjusting unit 120 executes emission timing adjusting control. In the emission timing adjusting control, in order to emit laser light DL at preset rotation angles of the rotating portion 52, generation of the drive signal by the drive pulse generating unit 140 is started using a correction value determined based on the rotation speed of the rotating portion 52 and the emission delay period so as to adjust the emission timing of laser light DL. The emission delay period represents the sum of the first delay period and the second delay period in the present embodiment. The emission delay period may be set to either the first delay period or the second delay period, or may be set to a fixed value. In this embodiment, the emission timing adjusting unit 120 uses a correction angle DT as the correction value stored in advance in the memory as the generation start timing of the drive signal. The correction angle DT can be calculated, for example, by multiplying the emission delay period by the rotation speed of the rotating portion 52. In this embodiment, the correction angle DT is set at a fixed value based on information such as data accumulated through tests or the like. The emission timing adjusting unit 120 may acquire the rotation angle of the rotating portion 52 from the rotation angle acquiring unit 110, and use a different correction value for each rotation angle to use a different correction angle DT for each rotation angle. In the case where the light emitting portion 40 emits laser light DL a plurality of times so that the ranging unit 150 generates a histogram by adding up the sums of the output signals of the SPADs, the correction angle DT may be used for the generation start timing of the drive signal for emitting laser light the first time when laser light DL is emitted a plurality of times for generating a single histogram. After the generation start timing of the drive signal for emitting laser light DL the first time, the drive signals for laser light DL to be emitted the second and subsequent times for generating a single histogram may be started to be generated at intervals of a predetermined time period determined according to, in addition to the correction angle DT, the rotation speed of the rotating portion 52, the time period in which the histogram is generated, and the like.

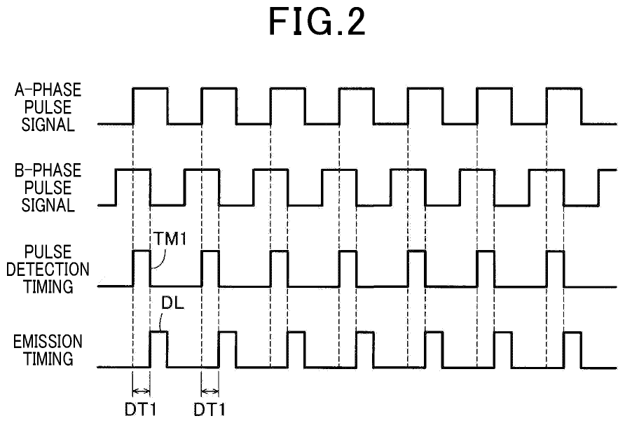

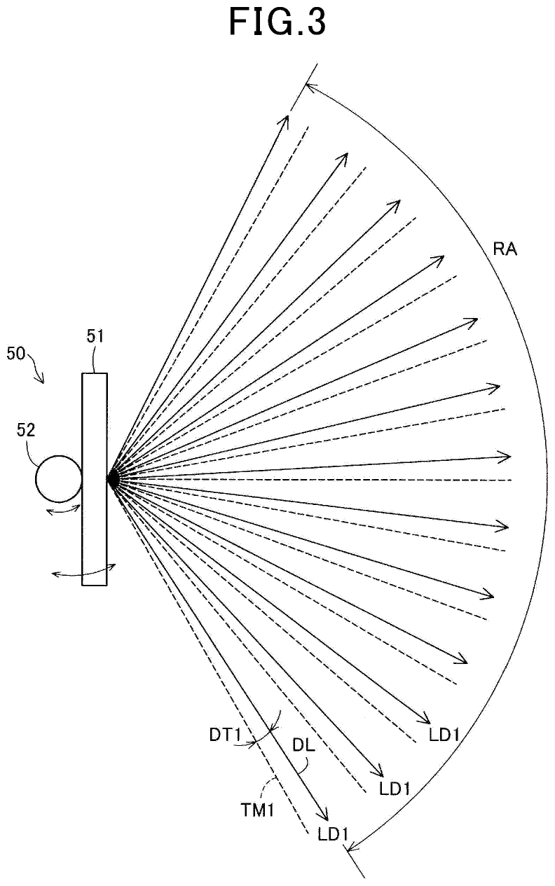

With reference to FIGS. 2 and 3, the emission timing adjusting control will be described in detail. As shown in FIG. 2, the rotation angle sensor 54 generates two rectangular wave pulse signals, namely, A- and B-phase pulse signals. The A- and B-phase pulse signals are output so that the phase of the A-phase pulse signal differs from the phase of the B-phase pulse signal by a quarter of the pitch. In FIG. 2, below the A- and B-phase pulse signals, the timings at which the rotation angle acquiring unit 110 detects pulse edges and the timings at which the light emitting portion 40 emits laser light DL upon receiving the drive signal are shown conceptually. In this embodiment, in the case where laser light DL is emitted a plurality of times to generate a single histogram, the timing at which laser light DL is emitted refers to the timing at which the first laser light DL is emitted. As will be described later, the pulse edge detection timing shown in FIG. 2 represents the timing at which a command signal for starting generation of a drive signal for emitting laser light DL at the intended rotation angle is output to the drive pulse generating unit 140. The timing at which a pulse edge is detected by the rotation angle acquiring unit 110 is controlled using a quarter of the pitch of the rectangular wave of each of the A- and B-phase pulses as the minimum unit.

In FIG. 3, the rotation angles of the rotating portion 52 at the timings when the rotation angle acquiring unit 110 detects pulse edges TM1 is conceptually shown by broken lines. The solid arrows shown in FIG. 3 indicate the rotation angles of the rotating portion 52 at the timings when laser light DL is emitted from the light emitting portion 40 upon receiving drive signals. In FIG. 3, set rotation angles LD1 are shown which are preset in the optical ranging device 200 of the present embodiment as the intended rotation angles for emitting laser light DL.

When the rotating portion 52 rotates, there will be a deviation between the rotation angle of the rotating portion 52 at the timing when the rotation angle acquiring unit 110 detects the pulse edge and the rotation angle of the rotating portion 52 at the timing when laser light DL is emitted from the light emitting portion 40 due to the above-described emission delay period. As described above, the error in the rotation angle is calculated by multiplying the rotation speed of the rotating portion 52 and the emission delay period.

As shown in FIGS. 2 and 3, a correction angle DT1 is set in this embodiment as an example of the correction angle DT. The correction angle DT1 corresponds to the angular difference between the rotation angle at the timing when the rotation angle acquiring unit 110 detects the pulse edge and the rotation angle at the timing when laser light DL is emitted. In other words, laser light DL is emitted at the timing when the rotating portion is rotated by the correction angle DT1 after the timing when the rotation angle acquiring unit 110 detects the pulse edge. The time it takes for the rotating portion 52 to rotate the mirror 51 by the correction angle DT1 includes the first delay period from when the drive pulse generating unit 140 generates the drive signal to when it is output to the light emitting portion 40, and the second delay period from when the drive signal is output to the light emitting portion 40 to when laser light DL is emitted by the light emitting portion 40. In this embodiment, the correction angle DT1 is calculated by multiplying the rotation speed of the rotating portion 52, which is rotated at a predetermined constant speed by the rotation angle control unit 130, by the emission delay period which is a preset value. The correction angle DT1 is, for example, a quarter of the pitch of the A-phase pulse signal, as shown in FIG. 2.

As shown in FIG. 3, in the optical ranging device 200 of this embodiment, generation of the drive signal is started when the rotation angle acquiring unit 110 detects the pulse edge at the timing that allows the light emitting portion 40 to emit laser light DL earlier than the preset rotation angle LD1 by the correction angle DT1. As described above, in this embodiment, since the rotation speed of the rotating portion 52 is a constant speed, for each of the rotation angles within the scanning range RA, generation of the drive signal is started at a timing that is earlier by the correction angle DT1. As a result, in the optical ranging device 200 of this embodiment, the rotation angle of the rotating portion 52 at the time when laser light DL is emitted from the light emitting portion 40 coincides with the set rotation angle LD1.

As described above, according to the optical ranging device 200 of the present embodiment, the control device 100 controls the drive pulse generating unit 140 so that it starts generating the drive signal at a timing that is earlier by the correction angle DT1 as a correction value determined using the emission delay period. Therefore, in an optical ranging device 200 that has emission delay, it is possible to reduce the deviation between the rotation angle of the rotating portion 52 at the timing when laser light DL is emitted from the light emitting portion 40 and the set rotation angle LD1 of the rotating portion 52, which is set in advance, at the timing for emitting laser light DL.

### B. Second Embodiment

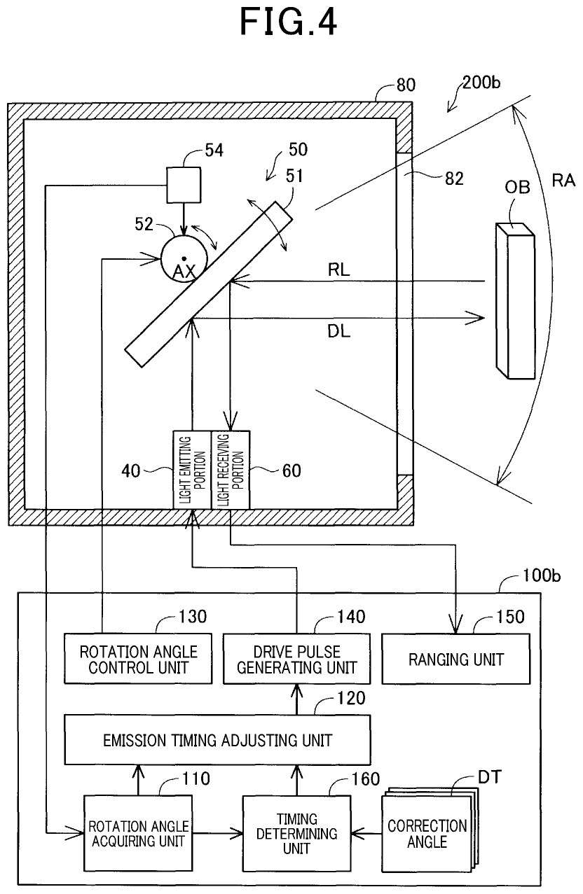

The optical ranging device 200b of the second embodiment sets a rotation speed of the rotating portion 52 for each of a plurality of regions within the scan range RA divided using the rotation angle, and outputs a drive signal at a timing corresponding to the rotation speed for each region. As shown in FIG. 4, the optical ranging device 200b of the second embodiment is similar to the optical ranging device 200 of the first embodiment, but differs from the optical ranging device 200 of the first embodiment in that it has a control device 100b in place of the control device 100. The control device 100b is different from the control device 100 in that it further includes a timing determining unit 160.

In this embodiment, the rotation angle control unit 130 makes the rotating portion 52 rotate back and forth in so-called simple harmonic motion. That is, the rotation speed of the rotating portion 52 is variable within the scan range RA, and the rotation speed of the rotating portion 52 is the fastest at the center of the scan range RA, and the rotation speed of the rotating portion 52 gradually decreases at it approaches the ends of the scan range RA.

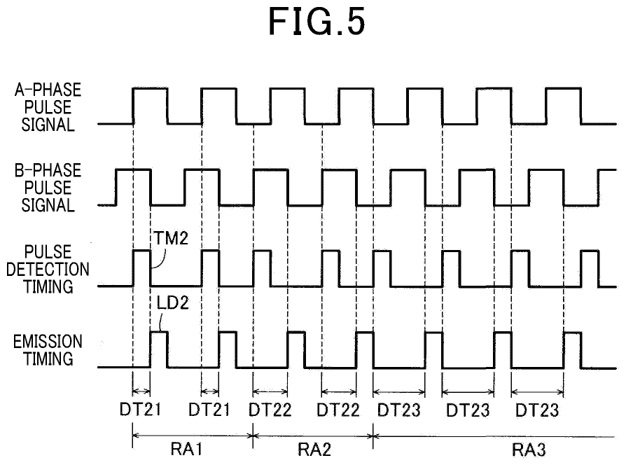

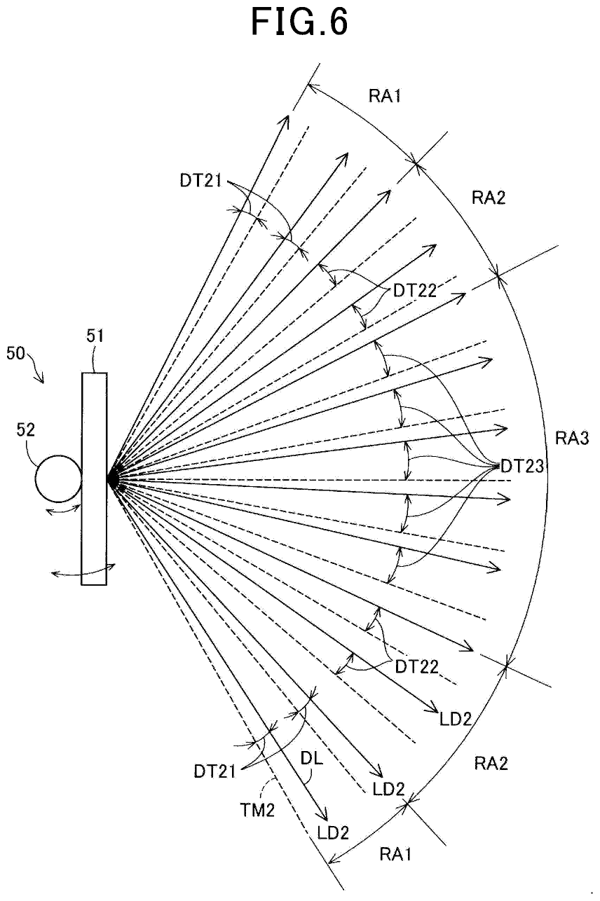

With reference to FIGS. 5 and 6, the emission timing adjusting control performed by the control device 100b will be described. In this embodiment, the control device 100b sequentially acquires the rotation angles of the rotation part 52 using the rotation angle acquiring unit 110, and outputs drive signals at the correction angles DT as correction values corresponding to the acquired rotation angles of the rotating portion 52.

As shown in FIG. 5, in this embodiment, correction angles DT21, DT22, and DT23 are stored in the memory in advance as the correction angles DT. In this embodiment, each of the divided regions within the scan range RA is assigned with one of the correction angles DT21 to

DT23. The scan range RA is divided into three regions RA1 to RA3 corresponding to the rotation speed of the rotating portion 52. The regions RA1 to RA3 are preferably set so that they are divided at each change point of the rotation speed of the rotating portion 52. For convenience of explanation, the regions RA1 to RA3 are conceptually shown in FIGS. 5 and 6. The rotation speed of the rotating portion 52 is the slowest in the region RA1 and the fastest in the region RA3. The scan range RA may be divided into any number of regions other than three in accordance with the changes in the rotation speed of the rotating portion 52, such as five or ten.

The correction angles DT21 to DT23 are set using the average of the rotation speeds of the rotating portion 52 in the regions RA1 to RA3 and the emission delay period. The correction angle DT21 is, for example, a quarter of the pitch of the A-phase pulse signal. The correction angle DT22 is, for example, half the pitch of the A-phase pulse signal. The correction angle DT23 is, for example, three quarters of the pitch of the A-phase pulse signal. The correction angles DT21 to DT23 may be set using the maximum value of the rotation speeds of the rotating portion 52 in the regions RA1 to RA3 and the emission delay period.

In FIG. 6, the rotation angles of the rotating portion 52 at the timings when the rotation angle acquiring unit 110 detects pulse edges TM2 are conceptually shown by broken lines. The solid arrows shown in FIG. 6 indicate the rotation angles of the rotating portion 52 at the timings when laser light DL is emitted from the light emitting portion 40 upon receiving drive signals. In FIG. 6, set rotation angles LD2 are shown which are preset in the optical ranging device 200b of the present embodiment as the intended rotation angles for emitting laser light DL.

The emission timing adjusting unit 120 acquires the rotation angle from the rotation angle acquiring unit 110, and determines to which of the regions RA1 to RA3 does the rotating portion's angle belong according to the acquired rotation angle. The emission timing adjusting unit 120 reads out one of the correction angles DT21 to DT23 corresponding to the determined region. The emission timing adjusting unit 120 starts generating the drive signal when the pulse edge is detected at the timing that is earlier by the one of the correction angles DT21 to DT23 that has been read out. According to the optical ranging device 200b of the present embodiment, the deviation between the rotation angle of the rotating portion 52 at the time when the light emitting portion 40 emits laser light DL and the set rotation angle LD2 is reduced in each of the regions RA1 to RA3 by using the correction angles DT21 to DT23 as correction values corresponding to the regions RA1 to RA3 having different rotation speeds.

As described above, according to the optical ranging device 200b of the present embodiment, the control device 100b acquires the rotation angle of the rotating portion 52, and starts generating the drive signal at a timing corresponding to the rotation speed for each rotation angle. Therefore, even when the rotation speed of the rotating portion 52 of the optical ranging device 200b changes, it is possible to reduce the deviation between the rotation angle of the rotating portion 52 at the timing when laser light DL is emitted from the light emitting portion 40 and the set rotation angle LD2.

According to the optical ranging device 200b, a rotation speed of the rotating portion 52 is set for each of the regions RA1 to RA3 divided using the rotation angle, and generation of the drive signal is started at a timing corresponding to the rotation speed for each region. The deviation between the rotation angle of the rotating portion 52 at the timing when laser light DL is emitted from the light emitting portion 40 and the set rotation angle LD2 can be reduced with a simple method in which the calculation of the rotation speed of the rotating portion 52 is simplified.

### C. Third Embodiment

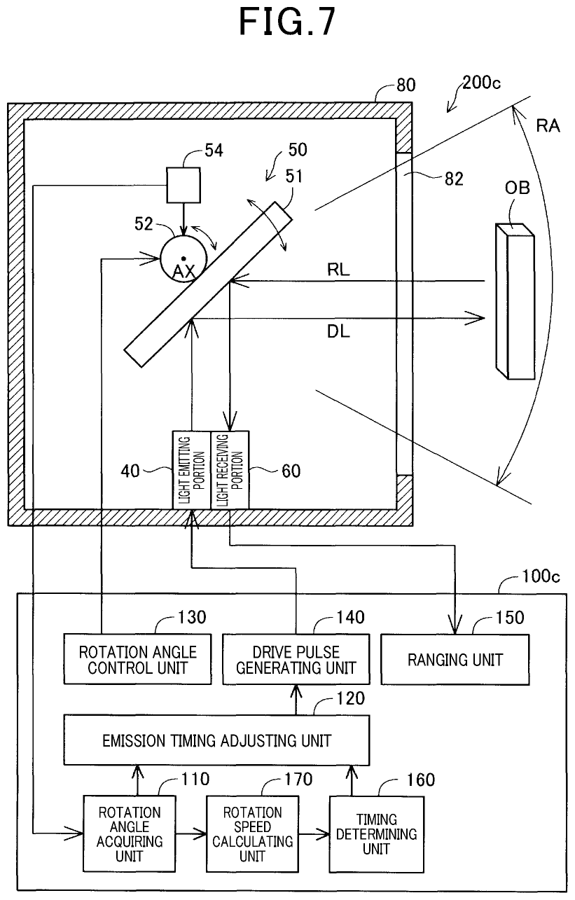

In the optical ranging device 200c of the third embodiment, the rotation speed is calculated at intervals of a predetermined rotation angle of the rotation part 52. The timing at which generation of the drive signal should be started is calculated for each rotation angle using the calculated rotation speed and the emission delay period. As shown in FIG. 7, the optical ranging device 200c of the third embodiment is similar to the optical ranging device 200 of the first embodiment, but differs from the optical ranging device 200 of the first embodiment in that it has a control device 100c in place of the control device 100. The control device 100c is different from the control device 100 in that it further includes a timing determining unit 160 and a rotation speed calculating unit 170.

In this embodiment, the rotation angle control unit 130 makes the rotating portion 52 rotate back and forth in so-called simple harmonic motion as with the second embodiment. The rotation speed calculating unit 170 acquires the rotation angle of the rotating portion 52 from the rotation angle acquiring unit 110 at intervals of a predetermined unit time, and calculates the rotation speed of the rotating portion 52 from the change in rotation angle per unit time. The rotation speed of the rotating portion 52 calculated by the rotation speed calculating unit 170 is output to the timing determining unit 160.

The timing determining unit 160 calculates a correction angle as a correction value for each rotation angle by using the calculated result of the rotation speed of the rotating portion 52 and the emission delay period. More specifically, for each rotation angle, the correction angle calculated by multiplying the rotation speed of the rotating portion 52 by the emission delay period is output to the emission timing adjusting unit 120. The emission timing adjusting unit 120 starts generating a drive signal when the pulse edge is detected at the timing that is earlier by the correction angle calculated for each rotation angle of the rotating portion 52.

According to the optical ranging device 200c, the rotation speed of the rotating portion 52 is calculated at intervals of a predetermined rotation angle of the rotation part 52. A correction angle is calculated for each rotation angle of the rotating portion 52 using the calculated rotation speed of the rotating portion 52 and the emission delay period, and generation of the drive signal is started at a timing earlier by the calculated correction angle. The deviation between the rotation angle of the rotating portion 52 at the timing when laser light DL is emitted from the light emitting portion 40 and the set rotation angle can be further reduced by using a correction angle that depends on the rotation speed of the rotating portion 52.

### D. Fourth Embodiment

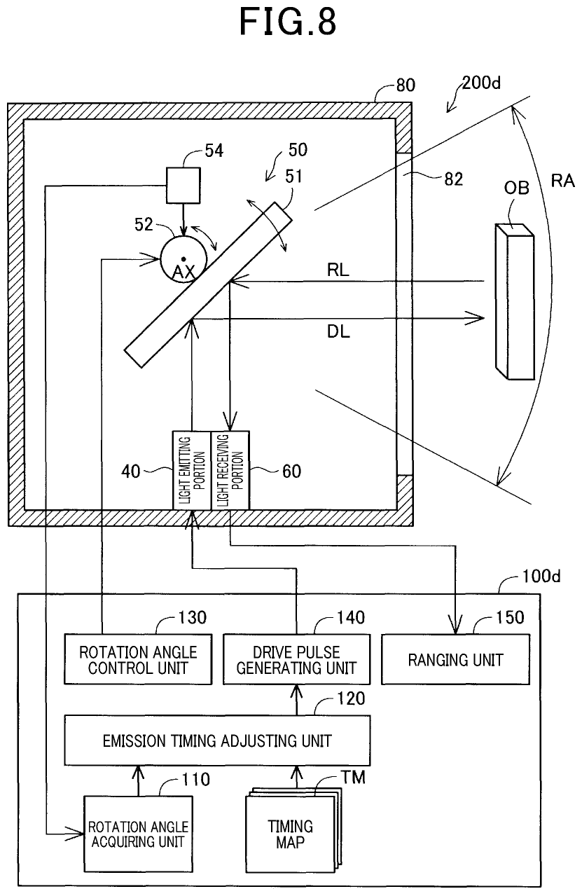

The optical ranging device 200d of the fourth embodiment performs the emission timing adjusting control using a timing map TM. As shown in FIG. 8, the optical ranging device 200d of the fourth embodiment is similar to the optical ranging device 200 of the first embodiment, but differs from the optical ranging device 200 of the first embodiment in that it has a control device 100d in place of the control device 100. The control device 100d is different from the control device 100 in that a timing map TM is stored in the memory in advance instead of the correction angle DT.

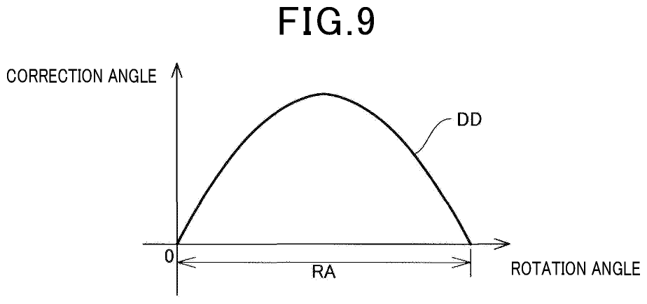

The timing map TM is a correspondence map showing the correspondence between the rotation angle of the rotating portion 52 and the correction angle as the correction value. As shown in FIG. 9, in the timing map TM, a correction angle DD is set for each of the rotation angles within the scan range RA. The correction angles DD are set in advance using, for example, the rotation speed values actually measured at different rotation angles of the rotating portion 52 in advance by, for example, conducting a test, and an actually measured value of the emission delay period acquired in advance by, for example, conducting a test. The correction angles may also be set by using empirical values of the rotation speed and emission delay period accumulated through use of the optical ranging device 200d or the like.

The emission timing adjusting unit 120 may receive the rotation angle of the rotating portion 52 from the rotation angle acquiring unit 110, and use the timing map TM to determine the correction angle DD corresponding to the received rotation angle. The emission timing adjusting unit 120 controls the drive pulse generating unit 140 so that generation of the drive signal is started when the pulse edge is detected at the timing that is earlier by the determined correction angle DD.

According to the optical ranging device 200d of this embodiment, the control device 100d has a timing map TM showing the correspondence between the rotation angle of the rotating portion 52 and the correction angle DD as the correction value. The emission timing adjusting unit 120 uses the timing map TM to determine the correction angles DD from the rotation speeds of the rotating portion 52 sequentially acquired from the rotation angle acquiring unit 110. Therefore, the deviation between the rotation angle of the rotating portion 52 at the timing when laser light DL is emitted from the light emitting portion 40 and the set rotation angle can be reduced using a simple method without requiring the control device 100d to perform complex computation.

### E. Fifth Embodiment

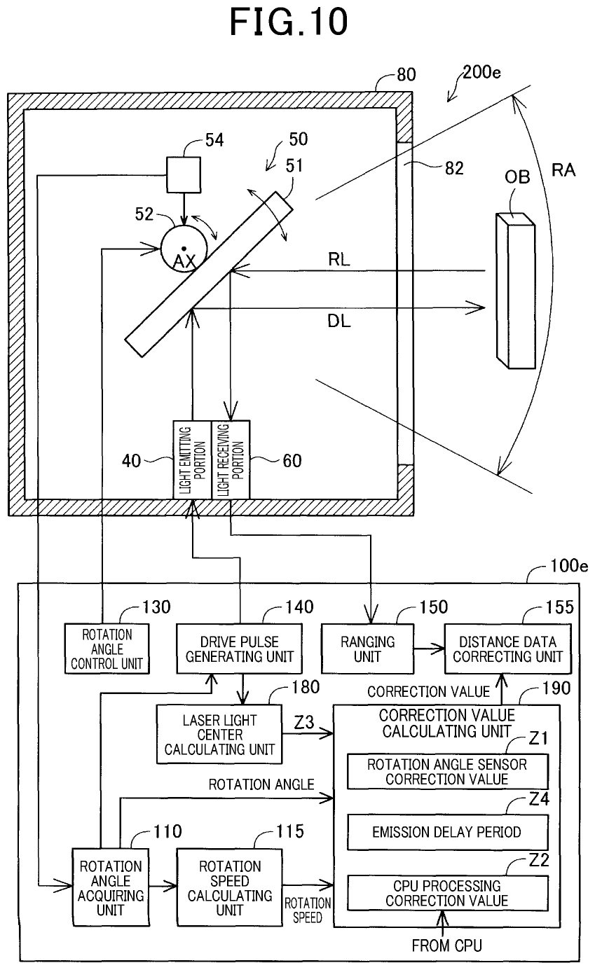

The configuration of an optical ranging device 200e according to the fifth embodiment will be described with reference to FIGS. 10 to 12. The optical ranging device 200e of the fifth embodiment corrects the distance data calculated by the ranging unit 150 with a correction value calculated using information such as the emission delay period. As shown in FIG. 10, the optical ranging device 200e is similar to the optical ranging device 200 of the first embodiment, but differs in that it has a control device 100e in place of the control device 100. The control device 100e is different from the control device 100 in that it includes, instead of the emission timing adjusting unit 120, a rotation speed calculating unit 115, laser light center calculating unit 180, a correction value calculating unit 190, and a distance data correcting unit 155.

The rotation speed calculating unit 115 calculates the rotation speed of the rotating portion 52 using the rotation angle acquired from the rotation angle acquiring unit 110. In the case laser light DL is emitted a plurality of times for one pulse detection timing, the laser light center calculating unit 180 calculates the center position of laser light DL emitted a plurality of times and outputs it as laser light center correction value Z3 to the correction value calculating unit 190. The correction value calculating unit 190 calculates a correction value for correcting the detection angle of the distance data. In this embodiment, the correction value calculating unit 190 calculates the correction value using a rotation angle sensor correction value Z1, a CPU processing correction value Z2, laser light center correction value Z3, and an emission delay period Z4. The distance data correcting unit 155 uses the correction value input from the correction value calculating unit 190 to correct the detection angle of each of the pieces of point cloud data acquired from the ranging unit 150.

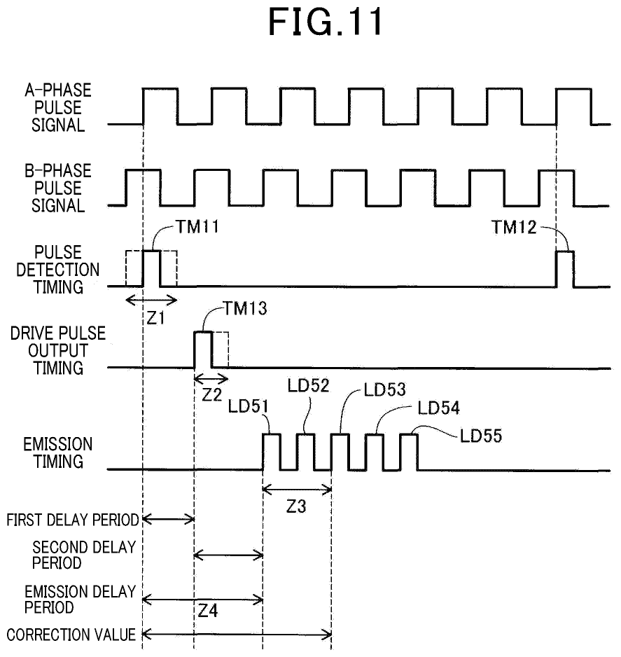

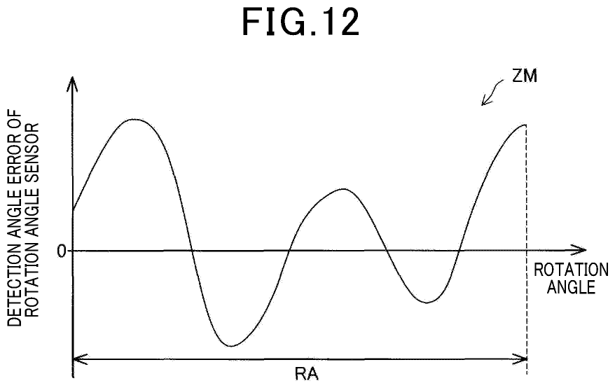

The correction value calculated by the correction value calculating unit 190 will be described with reference to FIGS. 11 and 12. FIG. 11 conceptually shows a pulse edge TM11 as an example of an edge detected by the rotation angle acquiring unit 110, an output timing TM13 of the drive pulse generated based on the detection of the pulse edge TM11, and the plurality of emission timings LD51 to LD55 at which laser light is emitted in response to the drive pulse at the output timing TM13. The pulse edge TM12 shown in FIG. 11 corresponds to the next rotation angle for emitting laser light after the pulse edge TM11.

The rotation speed calculating unit 115 calculates the rotation speed of the rotating portion 52 at the time the pulse edge TM12 is detected by using, for example, the rotation angle from the pulse edge TM11 to the pulse edge TM12 acquired from the rotation angle acquiring unit 110, and the period from when the pulse edge TM11 is detected to when the pulse edge TM12 is detected. The rotation speed of the rotating portion 52 at each pulse edge calculated by the rotation speed calculating unit 115 is output to the correction value calculating unit 190.

FIG. 11 conceptually shows the rotation angle sensor correction value Z1, the CPU processing correction value Z2, the laser light center correction value Z3, and the emission delay period Z4. The emission delay period Z4 is stored in the memory of the control device 100e as a preset fixed value.

The rotation angle sensor correction value Z1 is a correction value for correcting a mechanical error in the output timing of a pulse signal in the rotation angle sensor 54. The rotation angle sensor 54 may cause errors in the detection angles due to, for example, manufacturing variation in the spacing between the slits in the disc in the rotation angle sensor 54, variation in the position at which the rotation angle sensor 54 is placed in the housing 80, and the like. FIG. 12 shows an example of the correspondence relationship between the rotation angle detected by the rotation angle sensor 54 and the amount of the error in the detection angle. As shown in FIG. 12, the error in the detection angle of the rotation angle sensor 54 is different for each rotation angle. As shown in FIG. 12, the correspondence relationship between the rotation angle and the error in the detection angle of the rotation angle sensor 54 can be acquired by, for example, installing the rotation angle sensor 54 in the optical ranging device 200e and performing a test for comparing the detection results within the scan range RA of the rotation angle sensor 54 with the rotation angles of the rotating portion 52. Rotation angle sensor correction values Z1 correspond to the errors in the detection angles of the rotation angle sensor 54 shown in FIG. 12, and they are stored as a correspondence map in the memory of the control device 100e.

The CPU processing correction value Z2 is a correction value for correcting an error in the processing time of the microprocessor of the control device 100e. The CPU processing correction value Z2 differs depending on the processing capacity of the microprocessor. There may be variation in the processing time of the microprocessor from the moment the rotation angle is detected, which serves as laser light output timing, to the moment generation of the drive pulse is completed due to, for example, the microprocessor executing other control processing. The microprocessor of the control device 100e acquires the period from the moment the rotation angle is detected to the moment generation of the drive pulse is completed by using an internal clock, and outputs it to the correction value calculating unit 190. The correction value calculating unit 190 calculates the difference between the processing time acquired from the microprocessor and a predetermined standard processing time of the microprocessor, and calculates the CPU processing correction value Z2 for compensating the difference.

The laser light center correction value Z3 is a correction value used when laser light DL is emitted a plurality of times in response to one pulse edge TM11. It is used to set laser light DL emission timing to the median value of the period during which laser light DL is emitted a plurality of times. The median value refers to the median value of the period until all emission of laser light DL is finished. In this embodiment, the median value corresponds to half the time period from the first emission timing LD51 of laser light DL to the last emission timing LD55 of laser light. In this embodiment, the median value coincides with the third emission timing LD53 of laser light DL.

In the case laser light DL is emitted a plurality of times in response to one pulse edge TM11, laser light DL is emitted a plurality of times while the rotating portion 52 performs scanning. Therefore, in the case one point cloud dataset is to be generated based on a plurality of times of laser light DL, the plurality of times of laser light DL can be treated as a single laser light having a width corresponding to the number of times laser light DL is emitted. The center of the width is the median value. The laser light center calculating unit 180 uses the rotation speed acquired from the rotation speed calculating unit 115 and the number of times laser light DL is emitted acquired from the drive pulse generating unit 140 to calculate the laser light center correction value Z3 using, for example, the following Eq. (1).

Z3=V1·T1·(N1−1)/2 Eq. (1)
V1: The rotation speed of the rotating portion 52.
T1: The time between the first emission timing LD51 of laser light DL and the last emission timing LD55 of laser light.
N1: The number of times laser light DL is emitted.

The time T1 between the first emission timing LD51 of laser light DL and the last emission timing LD55 of laser light may be a theoretical value, and it may be calculated by adding up the output timings of laser light DL from the drive pulse generating unit 140.

The correction value calculating unit 190 multiplies the total time obtained by adding up the rotation angle sensor correction value Z1, the CPU processing correction value Z2, the laser light center correction value Z3, and the emission delay period Z4 by the rotation speed of the rotating portion 52 acquired from the rotation speed calculating unit 115, and outputs the calculated result to the distance data correcting unit 155 as the correction value. The distance data correcting unit 155 uses the correction values acquired from the correction value calculating unit 190 to correct the detection angles of the point cloud data corresponding to the pulse edge TM11.

According to the optical ranging device 200e of this embodiment, the control device 100e corrects the detection angles of the point cloud data generated by the ranging unit 150 using correction values determined using information such as the emission delay period Z4. The amount of deviation of the detection angles of the distance data can be decreased with a simple configuration without controlling the light emitting portion 40.

According to the optical ranging device 200e of this embodiment, the control device 100e further uses the detection errors in the rotation angles from the rotation angle sensor 54 to determine the correction values. The amount of deviation of the detection angles of the distance data can be further reduced by removing the detection errors in the detection angles from the rotation angle sensor 54.

According to the optical ranging device 200e of this embodiment, in the case laser light DL is emitted a plurality of times in response to a detected pulse edge TM11, the control device 100 determines the correction value using the median value of from the first emission timing LD51 of laser light DL to the last emission timing LD55 of laser light DL. This makes it possible to correct the detection angles of the distance data to even more proper values when one point cloud dataset is generated based on a plurality of times of laser light DL.

### F. Other Embodiments

(F1) The first embodiment sets one correction angle DT calculated using the rotation speed of the rotating portion 52 rotated at a constant speed and the emission delay period. It is also possible to set one correction angle DT for a rotating portion 52 whose rotation speed changes, such as a rotating portion 52 that rotates back and forth in simple harmonic motion. An optical ranging device of this mode can also reduce the deviation between the rotation angle of the rotating portion 52 at the timing when laser light DL is emitted from the light emitting portion 40 and the set rotation angle LD1. Alternatively, the correction angle DT may be calculated by using the intermediate value between the maximum and minimum values of the rotation speed of the rotating portion 52 within the scan range RA of the rotating portion 52. This makes it possible to reduce the deviation between the rotation angle of the rotating portion 52 at the moment laser light DL is emitted from the light emitting portion 40 and the set rotation angle using a simple method without requiring the control device 100 to perform complex computation. The correction angle DT may be calculated using the emission delay period and the average rotation speed of the rotating portion 52 within the scan range RA of the rotating portion 52.

(F2) In the above embodiments, a magnetic rotation angle sensor 54 may be employed instead of the optical rotation angle sensor 54, and also a rotation angle sensor 54 of the absolute type may be employed instead of the incremental type. A circuit that generates clock signals may be employed instead of the rotation angle sensor 54.

(F3) The above embodiments show examples in which the optical ranging device includes a control device, but the control device may be provided in a vehicle equipped with an optical ranging device. For example, a part of the functions of the control device, such as the distance data correcting unit 155 and the correction value calculating unit 190, may be provided in the vehicle. The weight of the optical ranging device can be reduced in this configuration.

(F4) Although the fifth embodiment shows an example where the control device 100e does not include the emission timing adjusting unit 120, the control device 100e may include the emission timing adjusting unit 120. In that case, the emission timing adjusting unit 120 may control the drive pulse generating unit 140 so that generation of the drive signal is started at a timing that is earlier by the correction angle acquired form the correction value calculating unit 190.

The control units and their methods described herein may be realized using a dedicated computer provided by configuring a processor and a memory programmed to execute one or more functions embodied by computer programs. Alternatively, the control units and their methods described herein may be realized using a dedicated computer provided by configuring a processor with one or more dedicated hardware logic circuits. Alternatively, the control units and their methods described herein may be realized using one or more dedicated computers configured by combining a processor and a memory programmed to execute one or more functions with a processor configured using one or more hardware logic circuits. The computer programs may be stored in a computer-readable, non-transitory tangible recording medium as instructions executed by the computer.

The present disclosure is not limited to the above embodiments, and can be implemented in various configurations without departing from the spirit of the present disclosure. For example, the technical features of the embodiments corresponding to the technical features described in “Summary of the Invention” may be replaced or combined as appropriate to solve part or all of the above-described problems, or achieve part or all of the above-described effects. When a technical feature is not described as an essential feature herein, it can be removed as appropriate.

What is claimed is:

1. An optical ranging device comprising:
a light emitting portion configured to emit laser light;
a scanning portion configured to perform a scan using the laser light emitted from the light emitting portion;
a light receiving portion configured to receive incident light;
a rotation angle sensor configured to detect a rotation angle of the scanning portion; and
a control device configured to:
acquire the rotation angle and output a drive signal to the light emitting portion, and
use a correction value to perform at least one of a first correction control and a second correction control,
the correction value being determined using at least an emission delay period from when the rotation angle is acquired to when the laser light is emitted, and a correspondence relationship between a rotation angle of the rotation angle sensor and a detection error in the rotation angle,
the first correction control being a correction of an emission timing of the laser light, and the second correction control being a correction of a detection angle of distance data generated using a received light signal output from the light receiving portion that received the laser light.

2. The optical ranging device according to claim 1, wherein
the control device is configured to determine the correction value by also using one half of a time from a first emission timing of laser light to a last emission timing of laser light, in response to the light emitting portion emitting laser light a plurality of times for one acquired rotation angle.

3. The optical ranging device according to claim 1, wherein
the control device is configured to calculate the correction value using an intermediate value between a maximum value and a minimum value of a rotation speed of the scanning portion within a scan range.

4. The optical ranging device according to claim 1, wherein
the control device is configured to calculate the correction value corresponding to a rotation speed of the scanning portion at each rotation angle.

5. The optical ranging device according to claim 4, wherein
the control device is configured to:
set a rotation speed of the scanning portion for each of a plurality of regions divided using the rotation angle, and
calculate the correction value using the rotation speed of the scanning portion set for each of the plurality of regions.

6. The optical ranging device according to claim 4, wherein
the control device is configured to:
calculate a rotation speed of the scanning portion for each predetermined rotation angle, and
calculate the correction value for each predetermined rotation angle using the calculated rotation speed of the scanning portion.

7. The optical ranging device according to claim 4, wherein
the control device is configured to use a correspondence map representing a correspondence relationship between the rotation angle and the correction value.
